(19) United States
(12) Patent Application Publication
(10) Pub. No.: US 2017/0209804 A1
(43) Pub. Date: Jul. 27, 2017

(54) SCENT-GENERATING APPARATUS AND SPECIAL-EFFECT EXPERIENTIAL CHAIR EQUIPPED WITH SAME

(71) Applicant: CJ 4DPLEX CO., LTD, Seoul (KR)

(72) Inventors: Hyeong Min KIM, Seoul (KR); Ho Young JEON, Seoul (KR)

(73) Assignee: CJ 4DPLEX CO., LTD, Seoul (KR)

(21) Appl. No.: 15/500,413

(22) PCT Filed: Jul. 31, 2015
(86) PCT No.: PCT/KR2015/008061

§ 371 Date: Jan. 30, 2017

(30) Foreign Application Priority Data
Aug. 1, 2014 (KR) 10-2014-0098938

(51) Int. Cl. A63J 25/00; B05B 15/06; A47C 1/12

(52) U.S. Cl. CPC A63J 25/00; A47C 1/12; B05B 15/06

(57) ABSTRACT

The present specification relates to a scent-generating apparatus and a special-effect experiential chair equipped with same, and more specifically, to a scent-generating apparatus which is installed in the interior or exterior of a movie theater and operates during a movie screening to release scent into the audience and impart olfactory effects, thereby maximizing the degree of immersion of the audience, and to a special-effect experiential chair equipped with the scent-generating apparatus.

### TECHNICAL FIELD

The present specification relates to a scent-generating apparatus and a special-effect experiential chair equipped with same, and more specifically, to a scent-generating apparatus which is installed in the interior or exterior of a movie theater and operates during a movie screening to release scent into the audience and impart olfactory effects, thereby maximizing the degree of immersion of the audience, and to a special-effect experiential chair equipped with the scent-generating apparatus.

### BACKGROUND ART

In general, a human's eyes mainly see three-dimensional stereoscopic images, but when an image captured by using an imaging device such as a camera or camcorder is displayed on a screen in a general movie theater, the image becomes a two-dimensional image, which causes a significant decrease in stereoscopic effect.

For this reason, recently, special-effect experiential chairs equipped with special-effect devices have been widely suggested for theaters, event halls of amusement parks, or stereoscopic movie theaters so that the audience may experience, at least indirectly, various situations in the images while seating in the chairs and watching the movies.

For example, vibration devices are mounted in the chairs of the movie theater and allow the chairs to automatically vibrate in conjunction with heavy low sound in the movie, thereby enabling the audience to experience sound of deeper feeling.

In addition, a chair is implemented which maximizes a degree of immersion by releasing scent toward the audience in accordance with a movie scene by using a scent-generating apparatus and imparting olfactory effects.

FIG. 1 is an explanatory view of a scent-generating apparatus in the related art. The scent-generating apparatus in the related art includes chambers 110 which generate a plurality of types of scent. The scent-generating apparatus in the related art controls a plurality of chambers, which generate the scent, respectively, thereby generating necessary scent.

The chamber 110 includes a non-woven fabric 111, an inlet 112, and an outlet 113. The non-woven fabric 111 is formed as a non-woven fabric or a foam container into which the scent permeates. Air is introduced into the inlet 112. Air including the scent is discharged through the outlet 113.

The scent-generating apparatus in the related art allows air to pass through the chamber 110 that accommodates the non-woven fabric and the foam container into which the scent permeates, thereby delivering the scent to the audience.

When the scent-generating apparatus in the related art is used for a certain period of time, concentration of the scent is decreased. Further, in the case of the scent-generating apparatus in the related art, the amount of used scent cannot be measured, and thus it is impossible to recognize a point in time to supplement the scent. In addition, the scent-generating apparatus in the related art delivers several types of scent through a single tube, and as a result, the scent may be mixed together. This may cause deterioration in intuition for the scent.

### DISCLOSURE

### Technical Problem

An object of some exemplary embodiments of the present specification is to provide a scent-generating apparatus which supplies scent matched with image information when the audience watches the image.

Another object of some exemplary embodiments of the present specification is to provide a scent-generating apparatus which operates in accordance with a switch signal by receiving a scent on/off signal, which is synchronized with the corresponding image and programmed, through a corresponding communication line (e.g., RS-485, CAN, etc.).

Still another object of some exemplary embodiments of the present specification is to provide a scent-generating apparatus which sprays a scent liquid stored in a chamber by using at least one of the Venturi effect and a pressure difference created by introduced air, collects the sprayed scent liquid through a filter, and supplies only scent gas (aromatic compound) to a tube, thereby maintaining the scent always having constant concentration.

Yet another object of some exemplary embodiments of the present specification is to provide a scent-generating apparatus which directly uses a scent liquid, thereby directly measuring the amount of used scent liquid and checking a point in time to supplement the scent liquid.

Still yet another object of some exemplary embodiments of the present specification is to provide a scent-generating apparatus in which a multi-tube, which has tubes corresponding to types of scent, is connected to a portion adjacent to a 4D (4-dimensional) chair and the audience and delivers the scent to the audience, thereby preventing the scent from being mixed and improving intuition.

### Technical Solution

According to a first aspect of the present specification, there may be provided a scent-generating apparatus including: a liquid spray unit which has a first chamber that stores a scent liquid, and a sprayer that sprays the scent liquid stored in the first chamber; and a filter unit which has a filter that filters the scent liquid sprayed from the liquid spray unit, a second chamber in which the scent liquid filtered by the filter remains, and an air outlet that discharges scent gas generated as the scent liquid sprayed by the liquid spray unit is filtered.

The liquid spray unit may have a partition wall installed between the first chamber and the sprayer, an orifice tube may be provided in the partition wall, compressed air may be introduced into the first chamber through the orifice tube when the compressed air is introduced, and the scent liquid stored in the first chamber may be sprayed by using at least one of the Venturi effect and a pressure difference created by the introduced air.

The apparatus may further include a connecting tube which connects the first chamber and the second chamber, in which the filter unit filters the sprayed scent liquid, the filtered scent liquid remains in the second chamber, and the scent liquid remaining in the second chamber returns back to the first chamber through the connecting tube by using a pressure difference between the first chamber and the second chamber.

The connecting tube may further include a check valve which prevents the scent liquid from flowing reversely from the first chamber to the second chamber.

The apparatus may further include a level gauge which is connected to the first chamber or the second chamber, and indicates a level of the stored scent liquid by maintaining a level equal to a level of the scent liquid stored in the first chamber or the second chamber.

The apparatus may further include: a communication control unit which receives a scent on/off signal, and operates a switch signal based on the received scent on/off signal; and a multi-tube which has tubes corresponding to types of scent, and delivers the discharged scent gas, in which compressed air is introduced into the liquid spray unit in accordance with the operation of the switch signal, and the scent gas is discharged through the filter unit.

According to a second aspect of the present specification, there may be provided a special-effect experiential chair which provides a special effect and is equipped with a scent-generating apparatus including: a plurality of nozzles which is provided on the experiential chair, and sprays scent; a liquid spray unit which has a first chamber that stores a scent liquid, and a sprayer that sprays the scent liquid stored in the first chamber; and a filter unit which has a filter that filters the scent liquid sprayed from the liquid spray unit, a second chamber in which the scent liquid filtered by the filter remains, and an air outlet that discharges scent gas generated as the scent liquid sprayed by the liquid spray unit is filtered.

The liquid spray unit may have a partition wall installed between the first chamber and the sprayer, an orifice tube may be provided in the partition wall, compressed air may be introduced into the first chamber through the orifice tube when the compressed air is introduced, and the scent liquid stored in the first chamber may be sprayed by using at least one of the Venturi effect and a pressure difference created by the introduced air.

The scent-generating unit may further include a connecting tube which connects the first chamber and the second chamber, and the filter unit may filter the sprayed scent liquid, the filtered scent liquid may remain in the second chamber, and the scent liquid remaining in the second chamber may return back to the first chamber through the connecting tube by using a pressure difference between the first chamber and the second chamber.

The connecting tube may further include a check valve which prevents the scent liquid from flowing reversely from the first chamber to the second chamber.

The apparatus may further include a level gauge which is connected to the first chamber or the second chamber, and indicates a level of the stored scent liquid by maintaining a level equal to a level of the scent liquid stored in the first chamber or the second chamber.

The apparatus may further include: a communication control unit which receives a scent on/off signal, and operates a switch signal based on the received scent on/off signal; and a multi-tube which has tubes corresponding to types of scent, connects the plurality of nozzles and the scent-generating unit, and delivers the scent gas discharged from the scent-generating unit to the plurality of nozzles, in which compressed air is introduced into the liquid spray unit in accordance with the operation of the switch signal, such that the scent gas is discharged through the filter unit.

According to a third aspect of the present specification, there may be provided a scent-generating apparatus including: a liquid storage unit which has a first chamber that stores a scent liquid, and delivers the scent liquid stored in the first chamber to a scent spray unit; and the scent spray unit which has a second chamber installed with an air inlet through which air is introduced, a spray nozzle that sprays the scent liquid delivered from the liquid storage unit, and a scent member into which the sprayed scent liquid permeates and through which the air introduced from the air inlet passes to discharge scent gas.

The liquid storage unit may further include a level gauge which is connected to the first chamber, and indicates a level of the scent liquid stored in the first chamber by maintaining a level equal to a level of the scent liquid stored in the first chamber.

The scent spray unit may allow the scent liquid sprayed by the spray nozzle to permeate into the scent member before playing an image or at a desired point in time.

The scent spray unit may further include a collection hole which is installed at one side of the spray nozzle and collects the scent liquid stored in the second chamber of the scent spray unit.

The apparatus may further include: a connecting tube which connects the first chamber and the second chamber; a communication control unit which operates a first switch signal by receiving an on/off signal for spraying the scent liquid, and operates a second switch signal by receiving a scent on/off signal, before playing an image or a desired point in time; and a multi-tube which has tubes corresponding to types of scent, and delivers the discharged scent gas, in which based on the operation of the first switch signal, the scent liquid is delivered to the scent spray unit by the compressed air introduced into the liquid storage unit, and the scent spray unit sprays the scent liquid through the nozzle, and based on the operation of the second switch signal, the compressed air is introduced into the scent spray unit, such that scent gas is discharged from the scent liquid which permeates into the scent member.

According to a fourth aspect of the present specification, there may be provided a special-effect experiential chair which provides a special effect and is equipped with a scent-generating apparatus including: a plurality of nozzles which is provided on the experiential chair, and sprays scent; a liquid storage unit which has a first chamber that stores a scent liquid, and delivers the scent liquid stored in the first chamber; and a scent spray unit which has a second chamber installed with an air inlet through which air is introduced, a spray nozzle that sprays the scent liquid delivered from the liquid storage unit, and a scent member into which the sprayed scent liquid permeates and through which the air introduced from the air inlet passes to discharge scent gas.

The liquid storage unit may further include a level gauge which is connected to the first chamber, and indicates a level of the scent liquid stored in the first chamber by maintaining a level equal to a level of the scent liquid stored in the first chamber.

The scent spray unit may allow the scent liquid sprayed by the spray nozzle to permeate into the scent member before playing an image or at a desired point in time.

The scent spray unit may further include a collection hole which is installed at one side of the spray nozzle and collects the scent liquid stored in the second chamber of the scent spray unit.

The apparatus may further include: a connecting tube which connects the first chamber and the second chamber; a communication control unit which operates a first switch signal by receiving an on/off signal for spraying the scent liquid, and operates a second switch signal by receiving a scent on/off signal, before playing an image or a desired point in time; and a multi-tube which has tubes corresponding to types of scent, connects the plurality of nozzles and a scent-generating unit, and delivers the scent gas discharged from the scent-generating unit to the plurality of nozzles, in which based on the operation of the first switch signal, the scent liquid is delivered to the scent spray unit by the compressed air introduced into the liquid storage unit, and the scent spray unit sprays the scent liquid through the nozzle, and based on the operation of the second switch signal, the compressed air is introduced into the scent spray unit, such that scent gas is discharged from the scent liquid which permeates into the scent member.

### Advantageous Effects

According to some exemplary embodiments of the present specification, it is possible to supply scent matched with image information when the audience watches an image.

According to some exemplary embodiments of the present specification, it is possible to operate the scent-generating apparatus in accordance with a switch signal by receiving a scent on/off signal, which is synchronized with the corresponding image and programmed, through a corresponding communication line (e.g., RS-485, CAN, etc.).

According to some exemplary embodiments of the present specification, it is possible to maintain the scent always having constant concentration by spraying a scent liquid by using a pressure difference, the Venturi effect, or both of the pressure difference and the Venturi effect, by collecting the scent liquid through the filter, and by supplying only scent gas (aromatic compound) into a tube.

According to some exemplary embodiments of the present specification, the scent liquid is directly used, and as a result, it is possible to directly indicate the amount of used scent liquid, and to check a point in time to supplement the scent liquid.

According to some exemplary embodiments of the present specification, the multi-tube, which has the tubes corresponding to types of scent, is connected to a portion adjacent to a 4D (4-dimensional) chair and the audience, and delivers the scent to the audience, and as a result, it is possible to prevent the scent from being mixed, and to improve intuition.

### DESCRIPTION OF DRAWINGS

FIG. 1 is an explanatory view of a scent-generating apparatus in the related art.

FIGS. 2 and 3 are structural views of a scent-generating apparatus according to an exemplary embodiment of the present specification.

FIGS. 4 and 5 each are an exterior view and a cross-sectional view of a scent-generating unit of a scent-generating apparatus according to a first exemplary embodiment of the present specification.

FIGS. 6 and 7 are views for explaining a process of generating scent in the scent-generating unit according to the exemplary embodiment of the present specification.

FIG. 8 is a configuration view of an experiential chair in which the scent-generating apparatus according to the exemplary embodiment of the present specification is mounted.

FIG. 9 is a cross-sectional view of a scent-generating unit of a scent-generating apparatus according to a second exemplary embodiment of the present specification.

FIGS. 10 and 11 are views for explaining a process of generating scent in the scent-generating unit according to the second exemplary embodiment of the present specification.

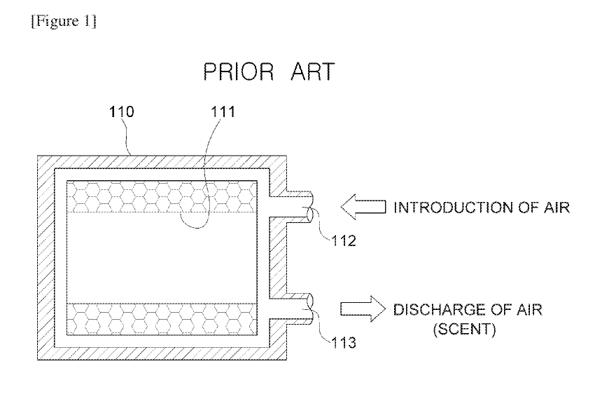

### DESCRIPTION OF MAIN REFERENCE NUMERALS OF DRAWINGS

200: Scent-generating apparatus
210, 900: Scent-generating unit
220: Communication control unit
230: Multi-tube
410: Liquid spray unit
411: Air inlet
412, 923: First chamber
413: Liquid spray unit
420: Filter unit
421: Air outlet
422, 913: Second chamber
423: Filter
430, 930: Connecting tube
431: Check valve
800: Special-effect experiential chair
810: Nozzle

### BEST MODE

Hereinafter, exemplary embodiments of the present specification will be described in detail with reference to the accompanying drawings.

In the description of the exemplary embodiment, a description of technical contents, which are well known in the technical field to which the present specification pertains and are not directly relevant to the present specification, will be omitted. The reason is to more clearly provide the subject matter of the present specification without obscuring the subject matter, by omitting the unnecessary descriptions.

For the same reason, some constituent elements are exaggerated, omitted, or schematically illustrated in the accompanying drawings. In addition, a size of each of the constituent elements does not completely reflect a real size. The same or corresponding constituent elements are designated by the same reference numerals in the respective drawings.

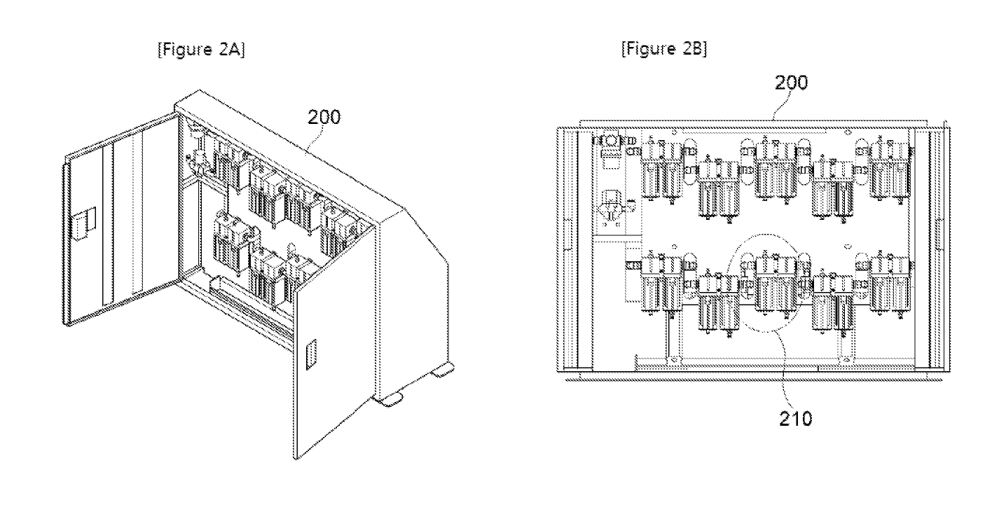

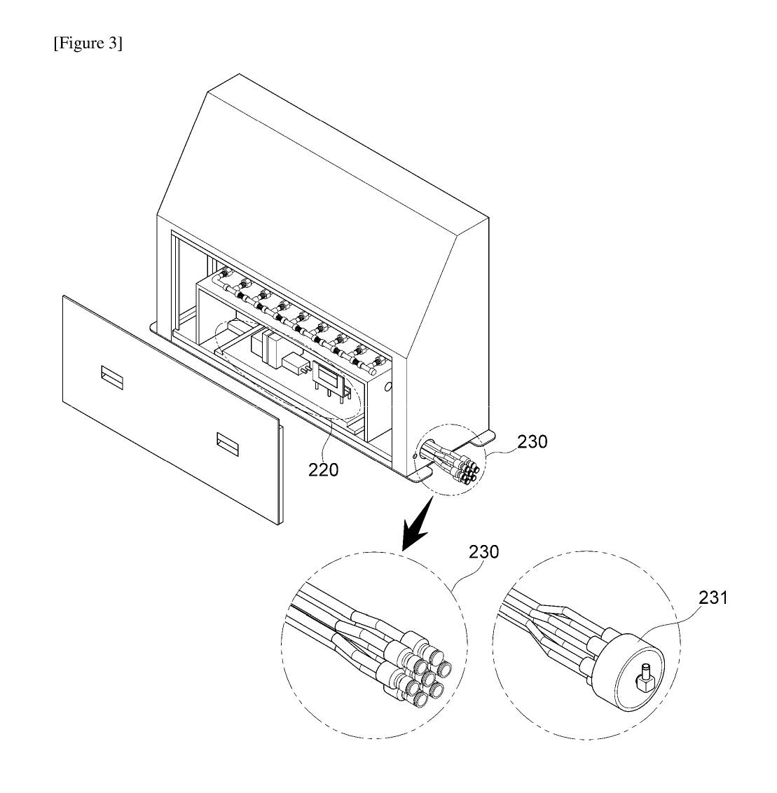

FIGS. 2 and 3 are structural views of a scent-generating apparatus according to an exemplary embodiment of the present specification.

Referring to FIGS. 2 and 3, a scent-generating apparatus 200 according to an exemplary embodiment of the present specification includes scent-generating units 210, a communication control unit 220, and a multi-tube 230.

The scent-generating apparatus 200 according to the exemplary embodiment of the present specification may be applied to various fields. Hereinafter, as the exemplary embodiment of the present specification, the scent-generating apparatus 200, which is applied to a 4D (4-dimensional) field, is described, but the present specification is not limited to a particular field.

Hereinafter, specific configurations and operations of the constituent elements in FIGS. 2 and 3 will be described.

The communication control unit 220 receives a scent on/off signal through a corresponding communication line (e.g., RS-485, CAN, etc.). The communication control unit 220 operates a switch signal based on the received scent on/off signal. Here, the scent on/off signal may be programmed by being synchronized with images screened in a movie theater. In this case, the communication control unit 220 may receive the scent on/off signal synchronized with the 4D images. That is, the communication control unit 220 may be applied to not only the scent on/off signal applied to the 4D field, but also various fields without being limited to a particular field as described above.

Further, the scent-generating unit 210 introduces compressed air based on the switch signal of the communication control unit 220. Subsequently, the scent-generating unit 210 sprays a stored scent liquid by using at least one of the Venturi effect and a pressure difference created by the introduced air. That is, the scent-generating unit 210 may spray the stored scent liquid by using a pressure difference between an inlet and an outlet, the Venturi effect, or both of the pressure difference and the Venturi effect. That is, the scent-generating unit 210 may spray the scent liquid by using only a pressure difference that is a mechanical pressure difference, or only the Venturi effect. In addition, the scent-generating unit 210 may spray the stored scent liquid by using both of the pressure difference and the Venturi effect.

In this case, the scent-generating unit 210 automatically collects the scent liquid through a filter, and discharges scent gas to the multi-tube 230. That is, a liquid remains in the filter, and only scent molecules, which are blown by air, are discharged.

As illustrated in FIG. 3, as a modified embodiment of the present specification, the multi-tube 230 may be connected with a check valve assembly 231 in which a plurality of check valves is coupled in the form of a joint.

Meanwhile, the scent-generating apparatus 200 may include one or more scent-generating units 210. The one or more scent-generating units 210 store different scent liquids, and one of the scent liquids may include scentless air (fresh air). For example, the scent-generating unit 210 may store a plurality of scent liquids separately having scent A to scent E, and the scentless air.

For the generation of the scentless air, the scent-generating unit 210 may be operated after no material or a scentless liquid is putted into the scent-generating unit 210 and then air flows. As another example, in the scent-generating unit 210, a tube may be connected directly to the multi-tube 230 without passing through the scent-generating unit 210 without the necessity of adding a scent-generating unit 210 for generating the scentless air. Because air is scentless, the scent-generating apparatus 200 may generate the scentless air without having an additional scent-generating unit 210.

Therefore, the scent-generating apparatus 200 discharges scent gas from the scent-generating unit 210 selected from the one or more scent-generating units 210. For example, in order to discharge scent C in accordance with an image scene, the scent-generating apparatus 200 may generate the scent C from the scent-generating unit 210 into which the scent C is introduced. This operation is performed by being controlled by the communication control unit 220 that controls the scent-generating apparatus 200.

The scent-generating unit 210 may clean the tube by spraying scentless air before or after discharging the scent and thus discharging the scent gas remaining in the form of gas in the multi-tube 230. In this case, the operation of spraying the scentless air may be performed each time before or after the scent gas is discharged, or may be performed for each predetermined cycle such as two or five times before or after the scent gas is discharged.

The multi-tube 230 is configured to meet types of scent. As an exemplary embodiment, the multi-tube 230 is connected to a portion adjacent to the 4D (4-dimensional) chair and the audience, and may deliver the scent to the audience. The multi-tube 230 prevents the scent from being mixed, thereby improving intuition. The multi-tube 230 may be applied to not only the 4D chair, but also various fields without being limited to a particular field as described above.

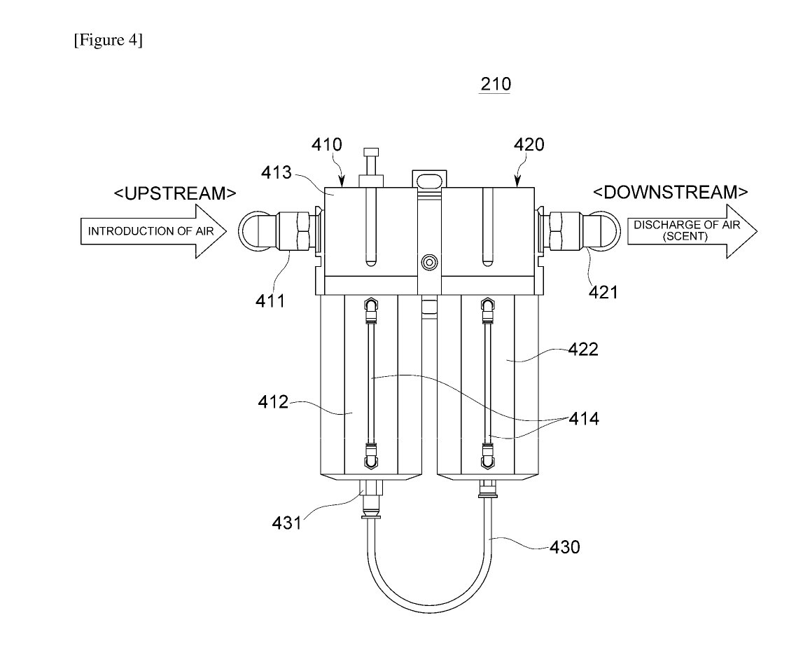

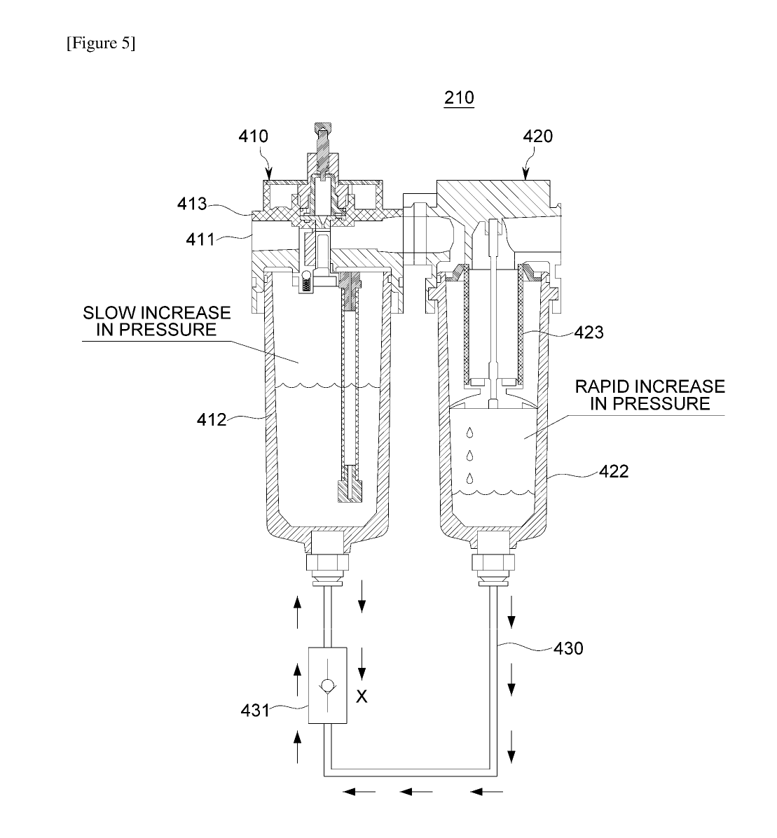

FIGS. 4 and 5 each are an exterior view and a cross-sectional view of a scent-generating unit of a scent-generating apparatus according to a first exemplary embodiment of the present specification.

Referring to FIGS. 4 and 5, the scent-generating unit 210 of the scent-generating apparatus 200 according to the exemplary embodiment of the present specification includes a liquid spray unit 410, a filter unit 420, and a connecting tube 430. Here, a side of the liquid spray unit 410 of the scent-generating unit 210 is an upstream side where the air is introduced, and a side of the filter unit 420 of the scent-generating unit 210 is a downstream side where the air is discharged.

The liquid spray unit 410 includes an air inlet 411, a first chamber 412, and a sprayer 413.

The liquid spray unit 410 receives compressed air through the air inlet 411.

The first chamber 412 stores the scent liquid.

The compressed air is introduced into the sprayer 413, and flows to the filter unit 420. Here, the sprayer 413 sprays the scent liquid stored in the first chamber 412.

A partition wall is installed between the first chamber 412 and the sprayer 413. An orifice tube is provided in the partition wall. When the compressed air is introduced, the compressed air is introduced into the first chamber 412 through the orifice tube. The liquid spray unit 410 sprays the scent liquid stored in the first chamber 412 by using at least one of the Venturi effect and a pressure difference created by the introduced air. Here, when the compressed air is introduced to the upstream side of the liquid spray unit 410, the compressed air is introduced into the first chamber 412 through the orifice tube. Pressure in the first chamber 412 is slowly increased.

Here, the scent-generating unit 210 may variably or constantly adjust the scent. Specifically, when the scent liquid moves up to the sprayer 413 from the first chamber 412, a predetermined amount of scent liquid drips in the sprayer 413. Here, the term “dripping” means that the scent liquid drops in the form of a droplet. In this case, a size of a flow path of a dripping portion through which the scent liquid flows is adjusted by moving a needle like a variable dripping type. In addition, the dripping portion may be variably adjusted as necessary so that a desired amount of scent liquid may flow through the dripping portion. As another exemplary embodiment, a size of the flow path is set when manufacturing the dripping portion like a fixed dripping type, such that the scent liquid may drip without variation (the dripping portion is not adjustable). The variable dripping type is applied to the scent-generating unit 210 illustrated in FIGS. 4 and 5. In a case in which the scent-generating apparatus 200 is applied to a movie theater, the variable dripping type may be applied to adjust the amount of dripping scent liquid in accordance with a size of the movie theater. The scent-generating apparatus 200 is not limited to the variable dripping type or the fixed dripping type.

Meanwhile, the filter unit 420 includes an air outlet 421, a second chamber 422, and a filter 423.

The filter unit 420 filters the scent liquid sprayed from the liquid spray unit 410, and discharges scent gas through the air outlet 421.

The filter 423 filters the scent liquid sprayed from the liquid spray unit 410. The scent liquid, which is filtered by the filter 423, remains in the second chamber 422.

The filter unit 420 has no partition wall between the filter 423 and the second chamber 422. When the compressed air is introduced into the upstream side, the compressed air is put directly into the second chamber 422. Therefore, pressure in the second chamber 422 is rapidly increased unlike the pressure in the first chamber 412. The scent liquid, which is collected in the second chamber 422, returns back to the first chamber 412 due to a pressure difference between the first chamber 412 and the second chamber 422.

The connecting tube 430 connects the first chamber 412 and the second chamber 422. The filter unit 420 filters the sprayed scent liquid, and the filtered scent liquid remains in the second chamber 422. The filter unit 420 returns the scent liquid remaining in the second chamber 422 back to the first chamber 412 through the connecting tube 430 by using a pressure difference between the first chamber 412 and the second chamber 422. The scent liquid in the second chamber 422 returns back to the first chamber 412 due to a pressure difference between the first chamber 412 and the second chamber 422. The connecting tube 430 may further include a check valve 431. In this case, the check valve 431 may prevent the scent liquid from flowing reversely from the first chamber 412 to the second chamber 422. Specifically, the check valve 431 allows the scent liquid to flow only in one direction from the second chamber 422 to the first chamber 412. The check valve 431 prevents the scent liquid from flowing reversely from the first chamber 412 to the second chamber 422. That is, the scent liquid stored in the first chamber 412 does not flow toward the second chamber 422.

The first chamber 412 and the second chamber 422 may be made of a metallic material. The chamber material may be metal due to a chemical reaction with the scent liquid. A separate chamber guard is not required because the chamber is made of a metallic material. For this reason, a user cannot observe interiors of the first chamber 412 and the second chamber 422 from the outside, and as a result, level gauges 414 are installed. A connecting tube is mounted to the level gauge 414, and as a result, the user may check a level of the scent liquid from the outside. The level gauge 414 is connected to the first chamber 412 or the second chamber 422, may maintain a level equal to a level of the scent liquid stored in the first chamber 412 or the second chamber 422, and may indicate a level of the stored scent liquid. Specifically, both sides of the level gauge 414 are connected to upper and lower portions of the second chamber 422, and since the level gauge 414 is connected to the upper and lower portions of the second chamber 422, the level gauge 414 maintains a level equal to a level of the scent liquid stored in the second chamber 422. The level gauge 414 indicates a level of the scent liquid stored in the second chamber 422 to the outside, thereby allowing the user to check the amount of used scent liquid and the amount of remaining scent liquid, and allowing the user to know a point in time to supplement the scent liquid. In addition, with the level gauge 414 that indicates a level of the scent liquid to the outside, it is possible to check the amount of used scent liquid, the amount of remaining scent liquid, a level of the scent liquid, and a point in time to supplement the scent liquid.

As a modified embodiment, the first chamber 412 and the second chamber 422 each have a chamber and a chamber guard. Here, the chamber actually stores the scent liquid, and may be made of a transparent plastic material. The chamber guard is a member for protecting the chamber, and may be made of a plastic or metal material. The chamber may have a structure which is opened vertically in an elongated manner and thus has a conspicuous interior. Therefore, the interior of the chamber may be observed from the outside, and the amount of used scent liquid stored in the chamber, the amount of remaining scent liquid, a level of the scent liquid, and a point in time to supplement the scent liquid may be checked from the outside.

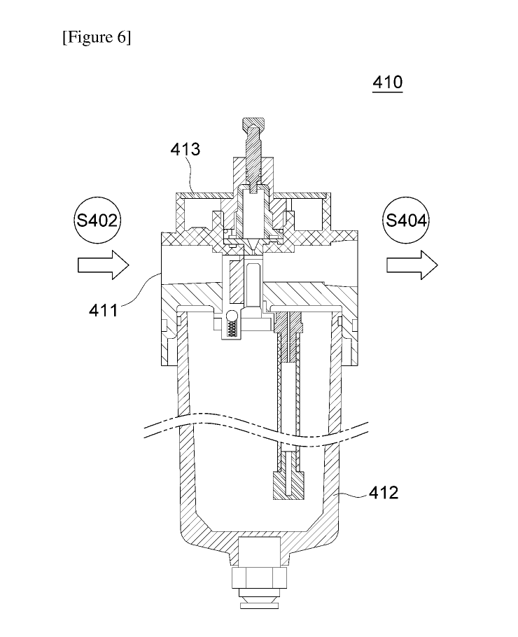

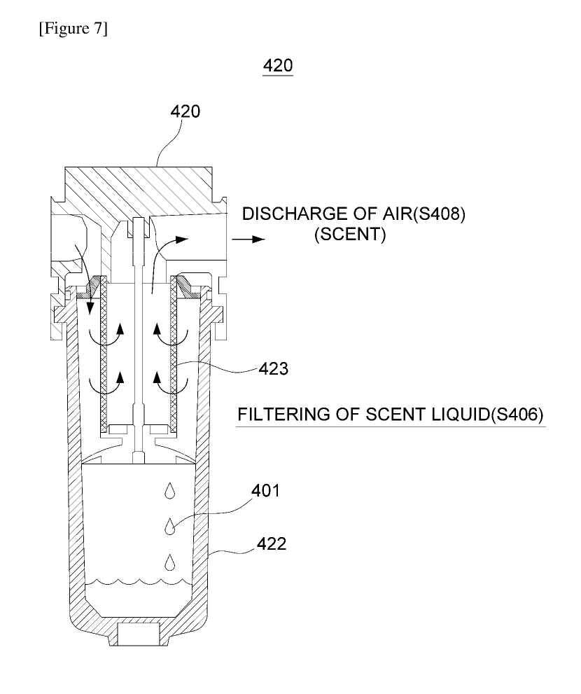

FIGS. 6 and 7 are views for explaining a process of generating the scent in the scent-generating unit according to the exemplary embodiment of the present specification.

The process of generating the scent in the scent-generating unit 210 will be described with reference to FIGS. 6 and 7.

In S402 in FIG. 6, when the compressed air is introduced to the upstream side of the liquid spray unit 410, the compressed air is introduced into the first chamber 412 through the orifice tube of the sprayer 413. Further, pressure in the first chamber 412 is slowly increased.

In contrast, when the compressed air is introduced into the upstream side, the compressed air is put directly into the second chamber 422. Therefore, pressure in the second chamber 422 is rapidly increased unlike the pressure in the first chamber 412.

Therefore, a pressure difference occurs for a certain period of time until the pressure in the first chamber 412 and the pressure in the second chamber 422 reach the same pressure.

In S404 in FIG. 6, the sprayer 413 sprays the scent liquid stored in the first chamber to the filter unit 420 by using the Venturi effect and a pressure difference between the inlet and the outlet.

In S406 in FIG. 7, the filter 423 filters the scent liquid delivered from the liquid spray unit 410, and collects the scent liquid. The collected scent liquid is stored in the second chamber 422.

Further, the collected scent liquid automatically returns back to the first chamber 412 of the liquid spray unit 410 through the connecting tube 430 connected to the second chamber 422 for the time when the pressure difference occurs between the first chamber 412 and the second chamber 422. Here, the check valve 431 allows the scent liquid to flow only in one direction, that is, only in a direction from the second chamber 422 to the first chamber 412. The scent liquid stored in the first chamber 412 does not flow toward the second chamber 422.

In S408 in FIG. 7, the filter unit 420 discharges the scent gas, which is generated by filtering the scent liquid by the filter 423, together with air. Here, the scent gas is composed of an aromatic compound that releases scent. Accordingly, the scent always having constant concentration may be maintained by performing the aforementioned process when it is necessary to generate the scent.

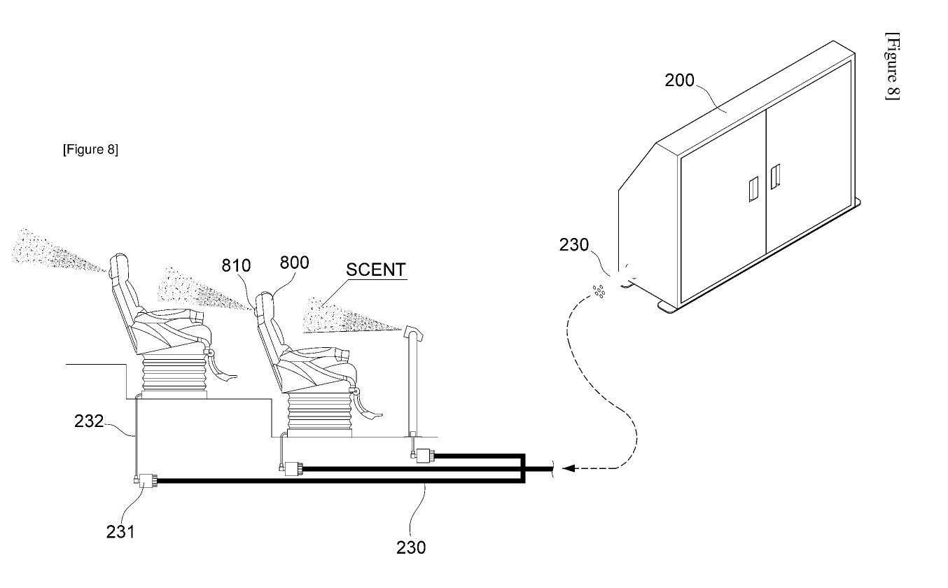

FIG. 8 is a configuration view of an experiential chair in which the scent-generating apparatus according to the exemplary embodiment of the present specification is mounted.

As illustrated in FIG. 8, the scent-generating apparatus 200 according to the exemplary embodiment of the present specification is installed at a rear side of a row of seats of special-effect experiential chairs 800, which are arranged in one direction, and generates the scent gas toward the audience seated in the corresponding row of seats or the audience seated in a rear row of seats. Here, the special-effect experiential chair 800 provides special effects to the audience seated in the respective seats so that the audience may indirectly experience various situations in the images.

To this end, the scent-generating apparatus 200 basically includes the scent-generating unit 210, the communication control unit 220, and the multi-tube 230. The scent-generating apparatus 200 may further include a plurality of nozzles 810 provided on the experiential chairs 100. The plurality of nozzles 810 sprays the scent, thereby stimulating olfactory senses of the audience. The plurality of nozzles 810 may be provided on the special-effect experiential chairs 100, respectively. In addition, the plurality of nozzles 810 may be provided only on the special-effect experiential chairs 100 having an even or odd number, or may be provided at an interval between two or more chairs.

Here, the multi-tube 230 of the scent-generating apparatus 200 may have check valve assemblies 231 which are mounted at positions adjacent to the special-effect experiential chairs 800, deliver the scent in the respective tubes only in one direction, and prevent the reverse flow of the scent. In addition, the check valve assemblies 231 may be connected with the plurality of nozzles 810 through common tubes 232.

The communication control unit 220 receives a programmed scent on/off signal through a corresponding communication line (e.g., RS-485, CAN, etc.). Further, the communication control unit 220 operates a switch signal to the scent-generating unit 210 based on the received scent on/off signal.

Only a single scent-generating unit 210 may be installed in a movie theater, and a plurality of scent-generating units 210 may be installed in a movie theater as necessary. Several special-effect experiential chairs 100 may be arranged correspondingly in a grouped manner.

The multi-tube 230 has the tubes corresponding to the types of scent, connects the plurality of nozzles 810 and the scent-generating unit 210, and delivers the scent gas discharged from the scent-generating unit 210 to the plurality of nozzles 810. Specifically, the multi-tube 230 supplies the scent sprayed from the scent-generating unit 210 to the plurality of nozzles 810. The multi-tube 230 may refer to tubing that connects the plurality of nozzles 810 with the scent-generating unit 210, and allows various types of scent to pass therethrough. The multi-tube 230, together with the plurality of nozzles 810, may be integrally installed on the special-effect experiential chairs 100.

Meanwhile, in the case of foremost seats, special-effect bars, which generate the scent gas toward the audience seated in seats in a foremost row, are provided instead of the special-effect experiential chairs 800. Therefore, the nozzle may be installed on the special-effect bar. The nozzle may be connected with the multi-tube 230.

In addition, the multi-tube 230 may have the check valve assemblies 231 mounted to deliver the scent in the respective tubes only in one direction and prevent the reverse flow of the scent. Therefore, the multi-tube 230 may prevent the scent gas, which is discharged from one or more scent-generating units 210, from flowing into another tube through the multi-tube 230.

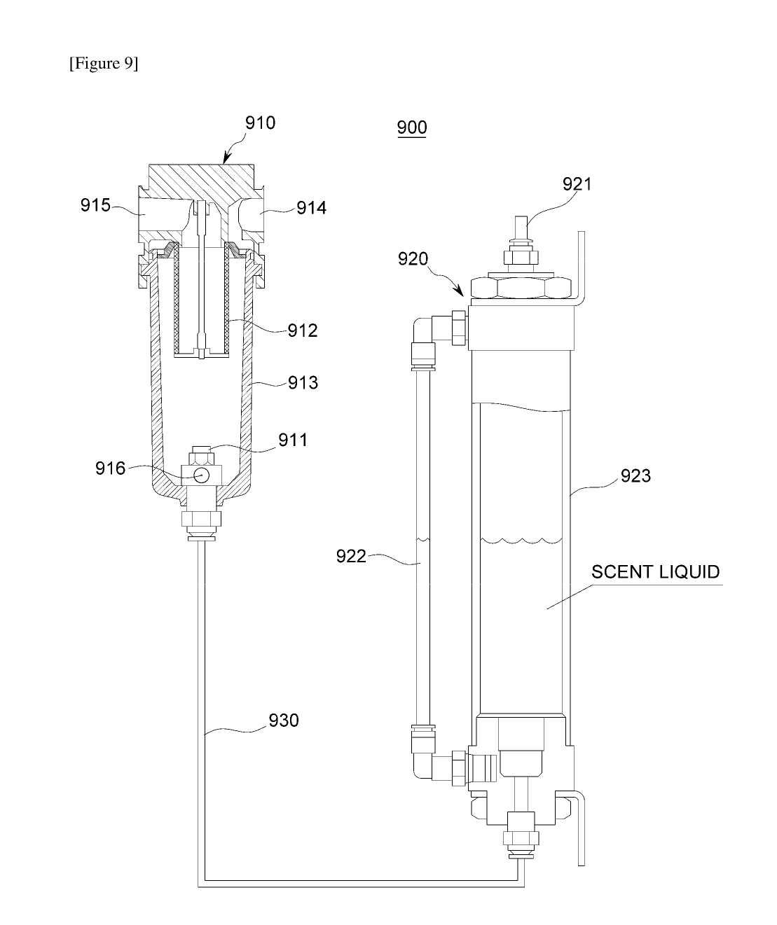

FIG. 9 is a cross-sectional view of a scent-generating unit of a scent-generating apparatus according to a second exemplary embodiment of the present specification.

Referring to FIG. 9, a scent-generating unit 900 of a scent-generating apparatus 200 according to the second exemplary embodiment of the present specification includes a scent spray unit 910, a liquid storage unit 920, and a connecting tube 930.

Here, the scent spray unit 910 includes a spray nozzle 911, a scent member 912, a second chamber 913, an air inlet 914, and an air outlet 915. The second chamber 913 includes therein the scent member 912 and the spray nozzle 911. Here, the spray nozzle 911 may further include a collection hole 916.

In addition, the liquid storage unit 920 includes an air inlet 921, a level gauge 922, and a first chamber 923. The first chamber 923 stores the scent liquid.

Hereinafter, the respective constituent elements of the scent-generating unit 900 of the scent-generating apparatus 200 according to the second exemplary embodiment of the present specification will be described with reference to FIG. 9.

First, the communication control unit 220 of the scent-generating apparatus 200 receives a programed on/off signal for spraying the scent liquid through a corresponding communication line (e.g., RS-485, CAN, etc.) before playing images or often, and operates a first switch signal.

Then, the liquid storage unit 920 receives compressed air through the air inlet 921 based on the first switch signal. The air inlet 921, through which the air is introduced, is installed on the liquid storage unit 920.

Further, the scent liquid stored in the first chamber 923 is delivered to the spray nozzle 911 of the scent spray unit 910 through the connecting tube 930 by the introduced compressed air. That is, the liquid storage unit 920 delivers the scent liquid stored in the first chamber 923. The spray nozzle 911 sprays the scent liquid delivered from the liquid storage unit 920. The sprayed scent liquid permeates into the scent member 912. When the compressed air is introduced into the scent spray unit 910, the scent gas is released, and at the same time, pressure of the compressed air is applied into the scent spray unit 910.

The scent member 912 is made of a non-woven fabric or a foam container. The scent liquid sprayed from the spray nozzle 911 permeates into the scent member 912, and the scent member 912 stores the scent liquid.

The level gauge 922 is connected to the first chamber 923, and indicates a level of the scent liquid stored in the first chamber 923 by maintaining a level equal to a level of the scent liquid stored in the first chamber 923. Specifically, both sides of the level gauge 922 are connected to upper and lower portions of the first chamber 923, and since the level gauge 922 is connected to the upper and lower portions of the first chamber 923, the level gauge 922 maintains a level equal to a level of the scent liquid stored in the first chamber 923. The level gauge 922 indicates a level of the scent liquid stored in the first chamber 923 to the outside, thereby allowing the user to check the amount of used scent liquid and the amount of remaining scent liquid, and allowing the user to know a point in time to supplement the scent liquid. In addition, with the level gauge 922 that indicates a level of the scent liquid to the outside, it is possible to check the amount of used scent liquid, the amount of remaining scent liquid, a level of the scent liquid, and a point in time to supplement the scent liquid.

The scent spray unit 910 maintains the scent always having constant concentration by allowing the scent liquid to permeate into the scent member 912 at a desired point in time and often, thereby maximizing scent generation performance.

Meanwhile, the communication control unit 220 of the scent-generating apparatus 200 receives a scent on/off signal, which is synchronized with the corresponding images and programmed, through a corresponding communication line (e.g., RS-485, CAN, etc.), and operates a second switch signal.

Then, based on the operation of the second switch signal, the scent spray unit 910 discharges the scent gas by allowing the scent liquid delivered from the liquid storage unit 920 to permeate into the scent member 912 through the spray nozzle 911, and allowing the introduced air to pass through the scent member 912. Specifically, the scent spray unit 910 receives the compressed air through the air inlet 914, and the introduced air passes through the scent member 912, and as a result, the scent gas is generated from the scent liquid that permeates into the scent member 912. Further, the scent spray unit 910 discharges the generated scent gas through the air outlet 915.

The connecting tube 930 connects the second chamber 913 and the first chamber 923. The scent liquid stored in the first chamber 923 is delivered to the spray nozzle 911 in the second chamber 913 by pressure of the compressed air introduced into the liquid storage unit 920.

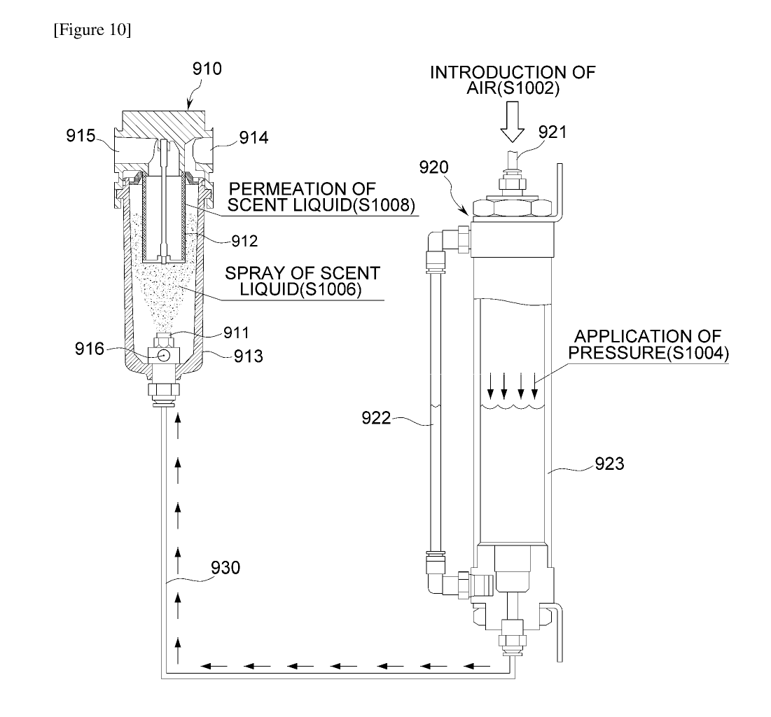

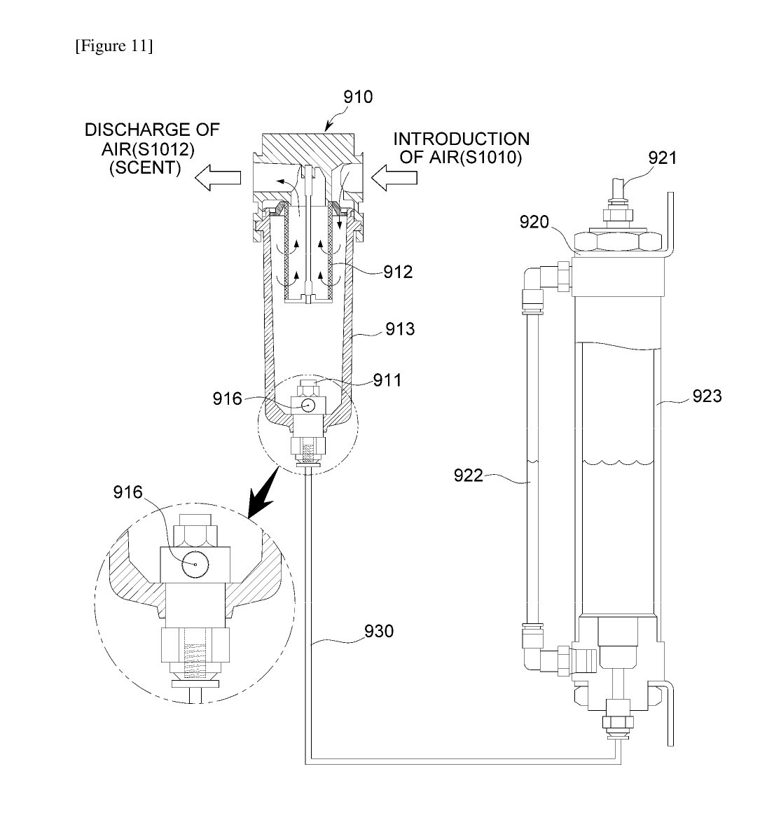

FIGS. 10 and 11 are views for explaining a process of generating the scent in the scent-generating unit according to the second exemplary embodiment of the present specification.

The process of generating the scent in the scent-generating unit 900 will be described with reference to FIGS. 10 and 11.

First, the communication control unit 220 of the scent-generating apparatus 200 receives the programed on/off signal for spraying the scent liquid through a corresponding communication line (e.g., RS-485, CAN, etc.) before playing images or often, and operates the first switch signal.

In S1002 in FIG. 10, the liquid storage unit 920 receives the compressed air through the air inlet 921 based on the first switch signal.

In S1004 in FIG. 10, the scent liquid stored in the first chamber 923 is delivered to the spray nozzle 911 of the scent spray unit 910 by an action of pressure of the introduced compressed air.

In S1006 in FIG. 10, the spray nozzle 911 sprays the scent liquid, which is delivered from the liquid storage unit 920, to the scent member 912.

In S1008 in FIG. 10, the scent liquid sprayed from the spray nozzle 911 permeates into the scent member 912.

Thereafter, the communication control unit 220 of the scent-generating apparatus 200 receives the scent on/off signal, which is synchronized with the corresponding images and programmed, through a corresponding communication line (e.g., RS-485, CAN, etc.), and operates the second switch signal.

In S1010 in FIG. 11, based on the operation of the second switch signal, the scent spray unit 910 receives the compressed air through the air inlet 914, and the introduced air passes through the scent member 912, and as a result, the scent gas is generated from the scent liquid that permeates into the scent member 912.

In S1012 in FIG. 11, the scent spray unit 910 discharges the generated scent gas through the air outlet 915.

Meanwhile, the scent spray unit 910 has the collection hole 916, which is installed at one side of the spray nozzle 911 and may collect a fine scent liquid, in addition to the spray nozzle 911. The scent liquid is collected through the collection hole 910 when pressure is applied into the scent spray unit 910, or the scent liquid, which is accumulated and remains in the scent spray unit 910 when the scent-generating apparatus 200 is left unattended over a long period of time, is collected through the collection hole 916. In addition, the collection hole 916 may prevent the spray nozzle 911 from being submerged in the scent liquid, thereby preventing the scent liquid from not being sprayed.

Even in a case in which the spray nozzle 911 sprays the scent liquid, the scent liquid flows out through the collection hole 916. However, because a hole size of the collection hole 916 is fine, the collection hole 916 does not affect the operation of spraying the scent liquid.

A person skilled in the art to which the present specification pertains may understand that the present specification may be carried out in other specific forms without changing the technical spirit or the essential characteristics of the present specification. Therefore, it should be understood that the above-described exemplary embodiments are illustrative in all aspects and do not limit the present specification. The scope of the present specification is represented by the claims to be described below rather than the detailed description, and it should be interpreted that all the changes or modified forms, which are derived from the meaning and the scope of the claims and the equivalents thereto, are included in the scope of the present specification.

Meanwhile, the exemplary embodiments of the present specification are disclosed in the present specification and the drawings, and specific terms are used, but the specific terms are used as general meanings merely for easily explaining the technical contents of the present specification and helping understand the present disclosure, but not intended to limit the scope of the present specification. It is obvious to those skilled in the art to which the present specification pertains that other modified embodiments may be carried out based on the technical spirit of the present specification in addition to the exemplary embodiments disclosed herein.

1-22. (canceled)

23. A scent-generating apparatus comprising:
a liquid spray unit which has a first chamber that stores a scent liquid, and a sprayer that sprays the scent liquid stored in the first chamber; and
a filter unit which has a filter that filters the scent liquid sprayed from the liquid spray unit, a second chamber in which the scent liquid filtered by the filter remains, and an air outlet that discharges scent gas generated as the scent liquid sprayed by the liquid spray unit is filtered.

24. The scent-generating apparatus of claim 23, wherein the liquid spray unit has a partition wall installed between the first chamber and the sprayer, an orifice tube is provided in the partition wall, compressed air is introduced into the first chamber through the orifice tube when the compressed air is introduced, and the scent liquid stored in the first chamber is sprayed by using at least one of the Venturi effect and a pressure difference created by the introduced air.

25. The scent-generating apparatus of claim 23, further comprising:
a connecting tube which connects the first chamber and the second chamber,
wherein the filter unit filters the sprayed scent liquid, the filtered scent liquid remains in the second chamber, and the scent liquid remaining in the second chamber returns back to the first chamber through the connecting tube by using a pressure difference between the first chamber and the second chamber.

26. The scent-generating apparatus of claim 25, wherein the connecting tube further includes a check valve which prevents the scent liquid from flowing reversely from the first chamber to the second chamber.

27. The scent-generating apparatus of any one of claims 23, further comprising:
a communication control unit which receives a scent on/off signal, and operates a switch signal based on the received scent on/off signal; and
a multi-tube which has tubes corresponding to types of scent, and delivers the discharged scent gas,
wherein compressed air is introduced into the liquid spray unit by the operation of the switch signal, such that the scent gas is discharged through the filter unit.

28. A special-effect experiential chair which provides a special effect and is equipped with a scent-generating apparatus comprising:
a plurality of nozzles which is provided on the experiential chair, and sprays scent;
a liquid spray unit which has a first chamber that stores a scent liquid, and a sprayer that sprays the scent liquid stored in the first chamber; and
a filter unit which has a filter that filters the scent liquid sprayed from the liquid spray unit, a second chamber in which the scent liquid filtered by the filter remains, and an air outlet that discharges scent gas generated as the scent liquid sprayed by the liquid spray unit is filtered.

29. The special-effect experiential chair of claim 28, wherein the liquid spray unit has a partition wall installed between the first chamber and the sprayer, an orifice tube is provided in the partition wall, compressed air is introduced into the first chamber through the orifice tube when the compressed air is introduced, and the scent liquid stored in the first chamber is sprayed by using at least one of the Venturi effect and a pressure difference created by the introduced air.

30. The special-effect experiential chair of claim 28, wherein scent-generating apparatus further includes a connecting tube which connects the first chamber and the second chamber, and the filter unit filters the sprayed scent liquid, the filtered scent liquid remains in the second chamber, and the scent liquid remaining in the second chamber returns back to the first chamber through the connecting tube by using a pressure difference between the first chamber and the second chamber.

31. The special-effect experiential chair of claim 30, wherein the connecting tube further includes a check valve which prevents the scent liquid from flowing reversely from the first chamber to the second chamber.

32. The special-effect experiential chair of any one of claims 28, wherein the scent-generating apparatus further includes:
a communication control unit which receives a scent on/off signal, and operates a switch signal based on the received scent on/off signal; and
a multi-tube which has tubes corresponding to types of scent, connects the plurality of nozzles and the scent-generating unit, and delivers the scent gas discharged from the scent-generating unit to the plurality of nozzles, and
compressed air is introduced into the liquid spray unit by the operation of the switch signal, such that the scent gas is discharged through the filter unit.

33. A scent-generating apparatus comprising:
a liquid storage unit which has a first chamber that stores a scent liquid, and delivers the scent liquid stored in the first chamber to a scent spray unit; and
the scent spray unit which has a second chamber installed with an air inlet through which air is introduced, a spray nozzle that sprays the scent liquid delivered from the liquid storage unit, and a scent member into which the sprayed scent liquid permeates and through which the air introduced from the air inlet passes to discharge scent gas.

34. The scent-generating apparatus of claim 33, wherein the liquid storage unit further includes a level gauge which is connected to the first chamber, and indicates a level of the scent liquid stored in the first chamber by maintaining a level equal to a level of the scent liquid stored in the first chamber.

35. The scent-generating apparatus of claim 33, wherein the scent spray unit allows the scent liquid sprayed by the spray nozzle to permeate into the scent member before playing an image or at a desired point in time.

36. The scent-generating apparatus of claim 33, wherein the scent spray unit further includes a collection hole which is installed at one side of the spray nozzle and collects the scent liquid stored in the second chamber of the scent spray unit.

37. The scent-generating apparatus of any one of claims 33, further comprising:
a connecting tube which connects the first chamber and the second chamber;
a communication control unit which operates a first switch signal by receiving an on/off signal for spraying the scent liquid, and operates a second switch signal by receiving a scent on/off signal, before playing an image or a desired point in time; and
a multi-tube which has tubes corresponding to types of scent, and delivers the discharged scent gas,
wherein based on the operation of the first switch signal, the scent liquid is delivered to the scent spray unit by the compressed air introduced into the liquid storage unit, and the scent spray unit sprays the scent liquid through the nozzle, and based on the operation of the second switch signal, the compressed air is introduced into the scent spray unit, such that scent gas is discharged from the scent liquid which permeates into the scent member.

38. A special-effect experiential chair which provides a special effect and is equipped with a scent-generating apparatus comprising:
a plurality of nozzles which is provided on the experiential chair, and sprays scent;
a liquid storage unit which has a first chamber that stores a scent liquid, and delivers the scent liquid stored in the first chamber; and
a scent spray unit which has a second chamber installed with an air inlet through which air is introduced, a spray nozzle that sprays the scent liquid delivered from the liquid storage unit, and a scent member into which the sprayed scent liquid permeates and through which the air introduced from the air inlet passes to discharge scent gas.

39. The special-effect experiential chair of claim 38, wherein the liquid storage unit further includes a level gauge which is connected to the first chamber, and indicates a level of the scent liquid stored in the first chamber by maintaining a level equal to a level of the scent liquid stored in the first chamber.

40. The special-effect experiential chair of claim 38, wherein the scent spray unit allows the scent liquid sprayed by the spray nozzle to permeate into the scent member before playing an image or at a desired point in time.

41. The special-effect experiential chair of claim 38, wherein the scent spray unit further includes a collection hole which is installed at one side of the spray nozzle and collects the scent liquid stored in the second chamber of the scent spray unit.

42. The special-effect experiential chair of any one of claims 38, wherein the scent-generating apparatus further includes:
a conn ting tube which connects the first chamber and the second chamber;
a communication control unit which operates a first switch signal by receiving an on/off signal for spraying the scent liquid, and operates a second switch signal by receiving a scent on/off signal, before playing an image or a desired point in time; and
a multi-tube which has tubes corresponding to types of scent, connects the plurality of nozzles and a scent-generating unit, and delivers the scent gas discharged from the scent-generating unit to the plurality of nozzles, and
based on the operation of the first switch signal, the scent liquid is delivered to the scent spray unit by the compressed air introduced into the liquid storage unit, and the scent spray unit sprays the scent liquid through the nozzle, and based on the operation of the second switch signal, the compressed air is introduced into the scent spray unit, such that scent gas is discharged from the scent liquid which permeates into the scent member.
